(19) United States
(12) Patent Application Publication
(10) Pub. No.: US 2026/0126281 A1
(43) Pub. Date: May 7, 2026

(54) TACTILE MEASUREMENT DEVICE

(71) Applicant: Franz Haimer Maschinenbau KG, Hollenbach-Igenhausen (DE)

(72) Inventor: Franz Haimer, Hollenbach-Igenhausen (DE)

(21) Appl. No.: 19/378,692

(22) Filed: Nov. 4, 2025

(30) Foreign Application Priority Data
Nov. 4, 2024 (DE) 10 2024 132 053.2

(51) Int. Cl. G01B 5/016

(52) U.S. Cl. CPC G01B 5/016

(57) ABSTRACT

A tactile measurement device has a housing, a touch probe lever mounted in the housing, and a carrier shaft which can be fastened on the housing radially adjustably, supported on the housing. Accordingly, the radial adjustment of the carrier shaft on the housing is made axially in the direction of the touch probe lever after the supporting contact of the carrier shaft on the housing.

### CROSS-REFERENCE TO RELATED APPLICATION

This application claims the priority, under 35 U.S.C. § 119, of German Patent Application DE 102024132 053.2, filed November 4, 2024; the prior application is herewith incorporated by reference in its entirety.

### FIELD AND BACKGROUND OF THE INVENTION

The invention relates to a tactile measurement device.

Tactile measurement instruments, here multi-coordinate tactile measurement instruments, are known, for example, from the German patent documents DE 41 00 323 C2 (corresponding to U.S. patent No. 5,365,673), DE 195 02 840 C2 and DE 100 14 630 A1.

Such multi-coordinate tactile measurement instruments can be clamped in machine tools (or measurement instruments or the like) or their spindles and allow the spindle axis to be positioned precisely at workpiece or device edges. Workpiece zero points can thus be set and length or distance measurements made quickly and simply.

In these known multi-coordinate tactile measurement instruments having inter alia a touch probe lever with a touch probe element at its end, their touch probe lever is displaceable in the direction of a main coordinate axis / measurement axis defined by guides of a housing and deflectable transversely to this main coordinate axis / measurement axis by means of a universal joint. The movements of the touch probe lever are detected by sensors and abovementioned length and distance values are calculated therefrom.

The housing is mounted, via corresponding support/guide or mating surfaces which bear against each other and are here normal to the axis, on a carrier shaft (referred to as a supporting/bearing contact for short), the axis of the carrier shaft running coaxially with the main coordinate axis / measurement axis in the use situation. Provided for holding/fixing the carrier shaft on the housing is an axial clamping screw which screws the carrier shaft to the housing under tension via the corresponding support/guide or mating surfaces which bear against each other and are here normal to the axis or via the bearing/supporting contact mentioned.

The multi-coordinate measurement instrument is then mounted in the spindle of the machine tool (or the measurement instrument) via a standard coupling (or a different tool holder), for example with a steep taper shaft.

In order to be able to center the center point of the touch probe element with the axis of rotation of the spindle of the machine tool or the measurement instrument, the housing engages, facing the carrier shaft, with a stub on the housing, into an opening in the carrier shaft which allows radial play between the carrier shaft and the stub.

The housing is thus, i.e. because of the play, radially movable and displaceable coaxially with the carrier shaft and can be centered or adjusted with the aid of multiple set/adjustment screws which are mounted on the carrier shaft and can be tightened against the stub (adjustment).

Such centering/adjustment formed by the carrier shaft and the housing (in order to achieve or ensure the centering of the center point of the touch probe element with the axis of rotation of the spindle) has a significant influence on the measurement accuracy of the multi-coordinate tactile measurement instrument. It furthermore largely defines the geometry, in particular the dimensions such as the length and size, of the multi-coordinate tactile measurement instrument.

### SUMMARY OF THE INVENTION

The object of the invention is to improve the multi-coordinate tactile measurement instrument known in the prior art.

This object is achieved by a tactile measurement device with the features of the independent claim.

Advantageous developments of the invention are the subject of dependent claims and the following description.

Terms which may be used, such as up, down, front, back, left or right, are, unless explicitly defined otherwise, to be understood with their usual meaning. Terms such as radial and axial are, where used and unless explicitly defined otherwise, to be understood with reference to center axes or axes of symmetry of parts/components described here.

The term “essentially”, where used, can be understood (in the understanding of the highest court) to mean “to a considerable degree in practice”. Possible deviations, implied by this terminology, from precise values can thus result unintentionally (i.e. for no functional reason) because of manufacturing or assembly tolerances or the like.

### Subject of the invention

The tactile measurement device, such as in particular a multi-coordinate tactile measurement device, provides a housing, a touch probe lever mounted in the housing, and a carrier shaft which is or can be fastened on the housing radially adjustably (“radial adjustment”), supported on the housing (“supporting/bearing contact”).

It is furthermore provided that the radial adjustment of the carrier shaft on the housing is made axially in the direction of the touch probe lever after the supporting contact of the carrier shaft on the housing. In short and expressed descriptively, the radial adjustment is positioned in front of the supporting contact, moving from the housing-side end of the carrier shaft in the axial direction.

The tactile measurement device can thus “shift”/“displace” the radial centering (in order to achieve or ensure the centering of the center point of the touch probe element with the axis of rotation of the spindle) within the outer contour of the housing or “into the housing”, as a result of which, the axial length of the tactile measurement device thus being reduced, the tactile measurement device can have a much more compact and stable structure and consequently the measurement accuracy of the measurement device can in turn also be improved.

Where the radial adjustment of the carrier shaft on the housing is or can be made axially in the direction of the touch probe lever after the supporting contact of the carrier shaft on the housing, and thus in particular (at the housing) at the end of the carrier shaft, the radial adjustment/centering can be made on a radially larger diameter, as a result of which the stability and the accuracy of the adjustment can also be increased again in the case of the tactile measurement device.

The tactile measurement device thus contributes to a significant improvement of tactile measurement instruments, in particular multi-coordinate tactile measurement instruments.

### Dependent subjects of the invention

The tactile measurement device can furthermore also provide that the carrier shaft has at one end a connecting flange which has an annular extension/portion forming a centering/adjustment opening. This therefore proves to be particularly advantageous because, by virtue of the connecting flange with a centering/adjustment opening, as mentioned the radial adjustment/centering can be on a radially larger diameter.

It can furthermore be provided that the housing has an annular groove forming a stub. It is here particularly expedient if the annular groove runs concentrically with the main coordinate axis / measurement axis (defined by guides of the touch probe lever in the housing). The stub is then formed centered on the main coordinate axis / measurement axis.

It is also particularly expedient if the stub is formed as a single piece with the housing as the stability of the tactile measurement device is increased as a result.

It can furthermore be provided that other outer surfaces of the housing protrude beyond an axial end side of the stub. Expressed descriptively, the stub is kept short, axially, and thus disappears inside the outer contour of the housing of the tactile measurement device, as a result of which the radial centering (in order to achieve or ensure the centering of the center point of the touch probe element with the axis of rotation of the spindle) can be “shifted”/“displaced” inside the outer contour of the housing or “into the housing”.

In particular, it is moreover expedient for the radial adjustment or setting of the center point of the touch probe element / axis of rotation of the spindle if the annular extension/portion engages with in particular radial (and/or axial) play in the annular groove (at the housing). The in particular radial play thus enables radial displacement of the housing relative to the carrier shaft or of the main coordinate axis / measurement axis relative to the carrier shaft axis, as a result of which the radial adjustment or the setting of the center point of the touch probe element / axis of rotation of the spindle can be effected.

It can also be provided that the annular extension/portion has a plurality of, preferably three or four, threaded holes, arranged uniformly distributed over the circumference, for adjustment/set screws. When the threaded ends of the adjustment screws are supported against the stub (when they are screwed into the threaded holes, the annular extension/portion engaging in the annular groove), the carrier shaft can be fixed to the housing in an aligned, centered position. The housing can in addition also provide through bores or openings or recesses through which the adjustment screws are plugged or pushed and can then be screwed into the threaded holes and turned with a corresponding spanner.

It is also preferred if a first support/guide or mating surface, forming the supporting contact and in particular normal to the axis, is formed at the stub or at its end side, and a corresponding (because it bears against the first support/guide or mating surface at the stub) second support/guide or mating surface, forming the supporting contact and in particular normal to the axis, is formed at the connecting flange or at an end side of the connecting flange. “Normal to the axis“ can here be understood with respect to the main coordinate axis / measurement axis, in particular in the case of the first support/guide or mating surface at the stub, or with respect to the carrier shaft axis, in particular in the case of the second support/guide or mating surface at the connecting flange.

It can furthermore be expedient here if the corresponding second support/guide or mating surface is formed at the connecting flange radially inside the annular extension/portion of the connecting flange. As a result, the supporting contact can be implemented radially inside the radial adjustment/centering - and the radial adjustment/centering can thus be made on a radially larger diameter.

It is also expedient if the carrier shaft has an axial bore for an axial clamping screw by means of which the carrier shaft can be screwed or clamped to the housing.

It can also preferably be provided that, in the case of the housing, a bush, having in particular an internal thread and to or into which a or the axial clamping screw can be connected or screwed, is inserted in particular in the stub of the housing, in an opening.

In a development, it can moreover be configured that the touch probe lever which is pivotable about a pivot point has at one end of the pivot point a touch probe / measuring arm having a touch probe / measuring tip with a touch probe element, and at the other end of the pivot point a coupling arm, wherein in particular a convex, in particular spherical, outer control surface is formed at the free end of the coupling arm.

It can here then furthermore also be provided that an in particular sleeve-shaped coupling piece is guided displaceable in the housing axially in the direction of a main coordinate axis / measurement axis and forms, in particular at one end, an inner control surface, bearing against the outer control surface, in the form of a frustoconical surface with preferably a linear generatrix.

A universal joint, for example in the form of a ball joint, can preferably be provided in order to achieve the pivotability of the touch probe lever, wherein the ball of the ball joint can be formed at the touch probe lever, and the socket in the housing.

The above description of advantageous embodiments of the invention includes numerous features which have sometimes been combined in multiples when repeated in the individual dependent claims. These features can, however, expediently also be considered individually and be combined in meaningful further combinations.

Also, when some terms are used in the description or in the claims in each case in the singular or in conjunction with a numeral, it is intended that the scope of the invention for these terms is not restricted to the singular or the respective numeral. Furthermore, the words “a” and “an” are not to be understood as quantifiers, but as indefinite articles.

The above-described properties, features and advantages of the invention and the manner in which these are achieved will become clearer and more readily understandable in conjunction with the following description of the exemplary embodiments of the invention which will be explained in conjunction with the drawings/figures(the same parts/components and functions have the same reference signs in the drawings/figures and, for the sake of clarity, have where appropriate not been entered in all the figures).

The exemplary embodiments serve to explain the invention and do not limit the invention to combinations, specified therein, of features and also not in terms of functional features. Moreover, suitable features of each exemplary embodiment can also, considered explicitly in isolation and extracted from an exemplary embodiment, be incorporated in a different exemplary embodiment in order to supplement it and/or be combined with any of the claims.

Other features which are considered as characteristic for the invention are set forth in the appended claims.

Although the invention is illustrated and described herein as embodied in a tactile measurement device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a first longitudinal sectional view of a multi-coordinate tactile measurement instrument in an embodiment according to the invention; and

FIG. 2 is second longitudinal section view of the multi-coordinate tactile measurement instrument in an embodiment according to the invention.

### DETAILED DESCRIPTION OF THE INVENTION

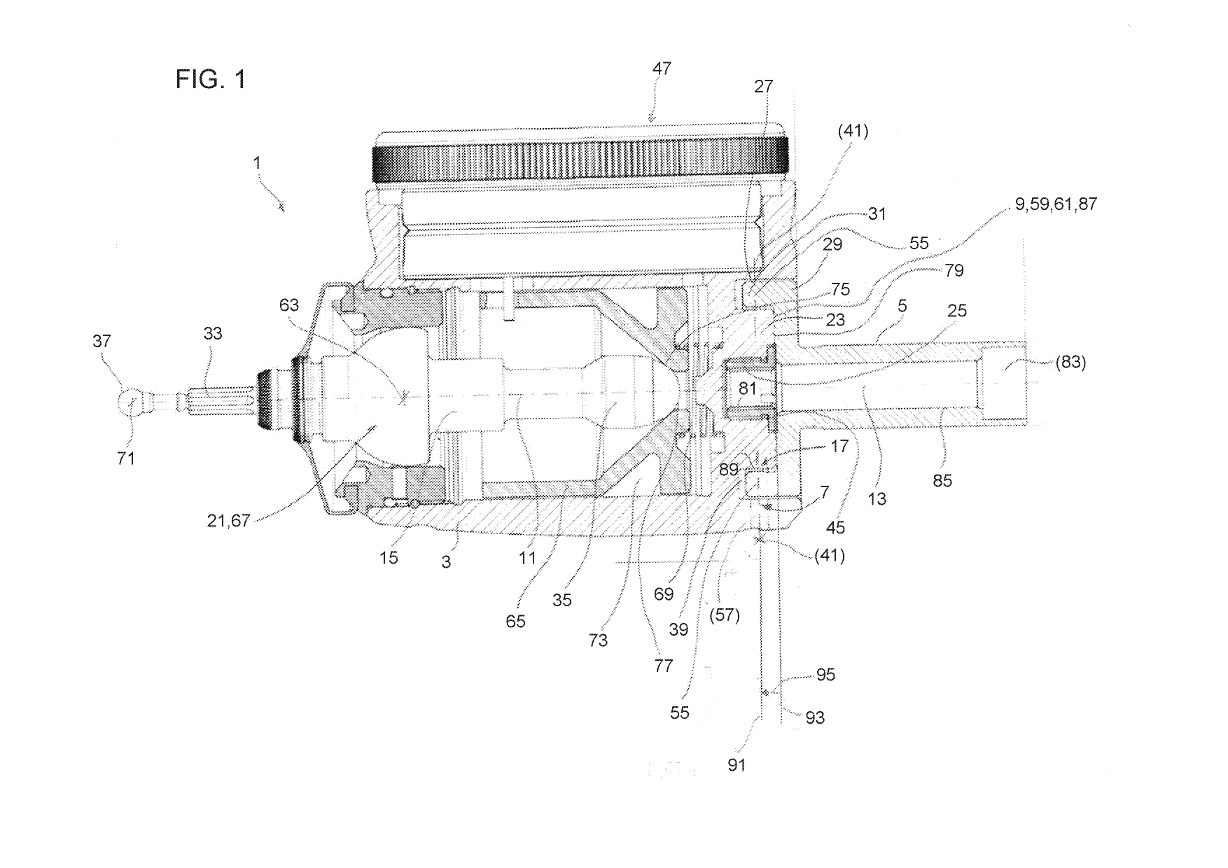

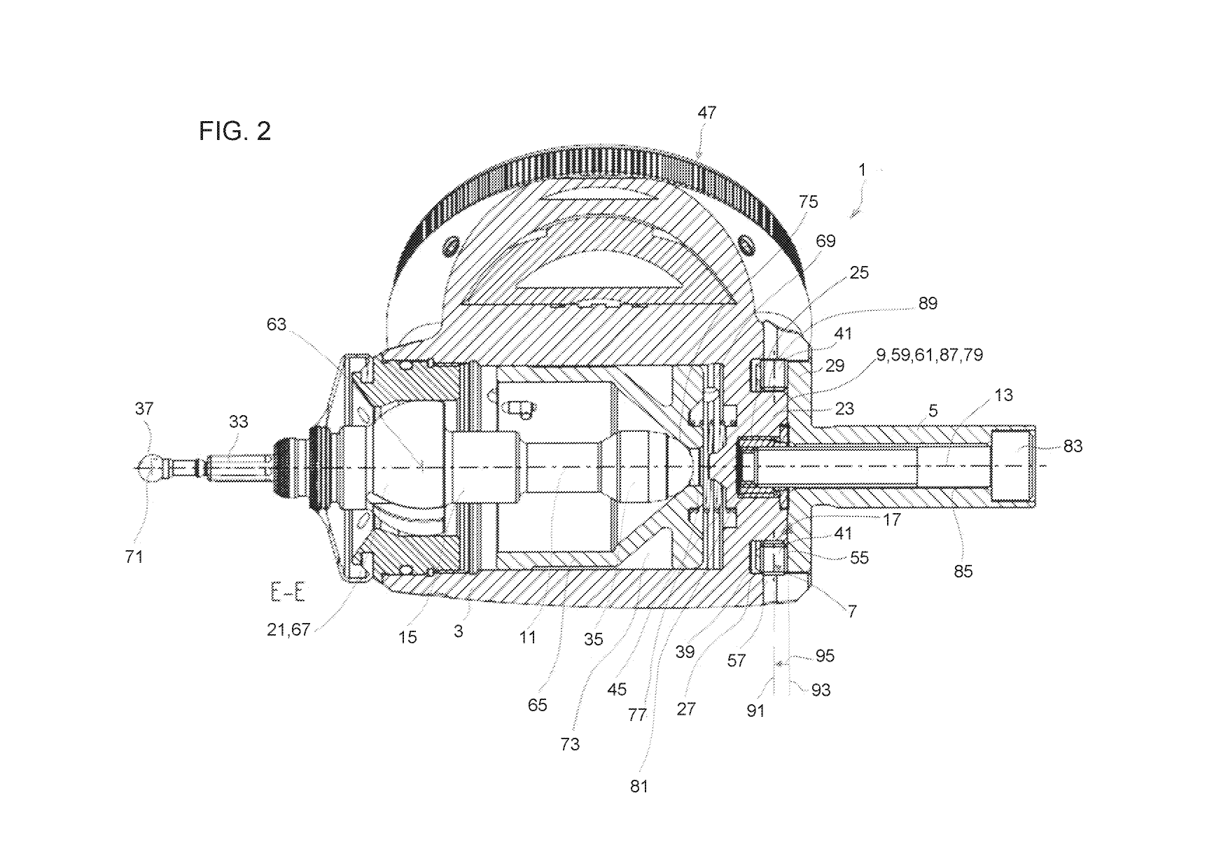

Referring now to the figures of the drawings in detail and first, particularly to FIGS. 1 and 2 thereof, there is shown a multi-coordinate measurement instrument with improved adjustment.

The multi-coordinate tactile measurement instrument designated generally by 1 in FIGS. 1 and 2, just tactile measurement instrument 1 for short below, contains a housing 3, at which a touch probe lever, designated generally by 15, is guided displaceable in the direction of a measurement axis 11 defined by the housing 3.

The touch probe lever 15 is furthermore guided at the housing 3 by means of a universal joint 21, here in the form of a ball joint 67, so that it can pivot on all sides about a pivot point 63 lying on a measurement axis 11, and is resiliently pretensioned into the rest position illustrated in the drawings by a return spring 69 in a manner which will be explained in greater detail below.

The touch probe lever 15 has a touch probe arm 33 projecting from the housing, the free touch probe end 37 or touch probe element 37 of which, formed by a ball, defines a touch probe reference point 71 lying on the measurement axis 11 in the rest position of the touch probe lever 15. With reference to the pivot point 63, a coupling arm 35 of the touch probe lever 15 projects in the opposite direction to the touch probe arm 33 into a circular-cylindrical guide opening 73, centered with respect to the measurement axis 11, of the housing 3.

An essentially sleeve-shaped coupling piece 65 is guided displaceable in the guide opening 73 in the direction of the measurement axis 11, for example by means of a guide sleeve, for example a ball guide socket of the type explained in non-prosecuted, published German patent application DE 100 14 630 (not shown).

A displacement measurement device mounted on the housing 3, in the form of an analogue gauge with a displacement sensor and a dial 47, records the position of the coupling piece 65 relative to the housing 3 by means of its displacement sensor and displays on its dial the value of the deflection relative to the rest position of the touch probe lever 15 illustrated in FIG. 1 and FIG. 2. A digital length gauge can also be provided instead of the analogue displacement measurement device.

The coupling piece 65 has, in the region of its end axially remote from the pivot point 63, an inner control surface 75 in the form of a frustoconical surface with a linear generatrix with which it bears against a convex outer control surface 77, formed at the free end of the coupling arm 35, of the touch probe lever 5. The inner control surface 75 is rotationally symmetrical with respect to the measurement axis 11, whereas the outer control surface 77 is rotationally symmetrical with respect to the straight line, coinciding with the measurement axis 11 in the rest position of the touch probe lever 15, through the touch probe reference point 71 and the pivot point 63. The outer control surface 77 has a generatrix in the shape of a segment of a circle. The return spring 69 pretensions the coupling piece 65 in the direction of the touch probe end 37 and at the same time ensures bearing contact pressure of the inner and outer control surfaces 75, 77 which bear against each other.

During operation, the tactile measurement instrument 1 is mounted in a machine tool or its spindle (or a measurement instrument or the like) via the carrier shaft 5 described in detail below by means of a standard coupling (not shown), for example a steep taper shaft.

In the case of a positioning movement of the touch probe end / touch probe element 37 made during the measuring in the direction of the measurement axis 11, the coupling arm 35 carries with it the coupling piece 65 which in turn positions the displacement measurement device 47. In the case of a positioning movement of the touch probe end / touch probe element 37 transversely to the measurement axis 11, the coupling arm 35 pivots about the pivot point 63 defined by the ball joint 67. The control surfaces 75 and 77 which slide on each other along their generatrixes during this pivoting movement of the coupling arm 35 convert the pivoting movement of the touch probe lever 15 into an axial movement of the sleeve-shaped coupling piece 65 in such a way that the displacement measurement device 47 measures the radial distance of the touch probe reference point 71 from the measurement axis 11. Reference should be made to published, non-prosecuted German patent application DE 100 14 630 A for further details of such a tactile measurement instrument.

The tactile measurement instrument 1 is provided with the carrier shaft 5 with which it can be clamped in the standard coupling (not shown) or another tool holder of the machine tool.

For precise measurements, it is required that the center point of the touch probe element 37 is centered on the axis of rotation of the spindle of the machine tool (or the measurement instrument).

In order to be able to compensate radial alignment errors (i.e. to be able to center radially), the housing 3 is mounted on the carrier shaft 5 via a mounting referred to as general centering mounting 7 (also as radial adjustment 7).

The centering mounting 7 makes it possible to be able to center the center point of the touch probe element 37 with the axis of rotation of the spindle of the machine tool (or the measurement instrument).

For implementing this centering mounting / radial adjustment 7, the carrier shaft 5 provides a radially protruding connecting flange 29 integrally formed as a single piece on the carrier shaft 5 with an annular extension/portion 31, axially facing the housing 3, forming a centering/adjustment opening 17.

A plurality of, in this example four, threaded holes 55, arranged uniformly distributed over the circumference, for adjustment screws 41 (only indicated) are provided at the annular extension/portion 31.

An annular groove 39 which is concentric with the measurement axis 11 forms a central stub 23, formed as a single piece with the housing 3, at the carrier shaft end of the housing 3, wherein other housing outer surfaces protrude axially beyond an axial end side 79 of the stub 23. Put in simplified and descriptive terms, the stub 23 is withdrawn into the housing contour.

A central opening 25 into which a bush 45 is inserted (screwed) is provided in the stub 23 or at its axial end side.

The bush 45 provides an internal thread 81, via which the carrier shaft 5 is screwed or clamped to the housing 3 by means of an axial clamping screw 83 (not illustrated) which passes through an axial bore 85 into the carrier shaft 5. The carrier shaft 5 thus comes into bearing/supporting contact 9 on the housing 3, and to be precise by means of a first support/guide or mating surface 59, forming the supporting contact and normal to the axis, at the stub 23 or at its end side 79 and a corresponding second support/guide or mating surface 61, forming the supporting contact and normal to the axis, at the connecting flange 29 or at an end side 87 (facing the housing 3) of the connecting flange 29 radially inside the annular extension/portion 31.

When the carrier shaft 5 is, as described, screwed (under tension) to the housing 3 by means of the axial clamping screw 83, the annular extension/portion 31 of the connecting flange 29 of the carrier shaft 5 engages with radial and axial play 27 into the annular groove 39 at the housing 3.

The in particular radial play 27 of the annular extension/portion 31 in the annular groove 39 thus enables the radial adjustment/centering of the touch probe element 37 on the spindle axis of rotation in such a way that the adjustment screws / set screws 41 which sit in the radial threaded holes 55 arranged distributed in the circumferential direction and are accessible radially from outside (through openings or bores 57 in the housing 3) are supported with their inner ends on the groove-side wall 89 of the stub 23 when the adjustment/setting by being screwed in takes place, and thus (radially) position the carrier shaft 5 with its carrier shaft axis 13 or the measurement axis 11.

It is essential in the case of the tactile measurement device 1 that, as shown in FIG. 1 and FIG. 2, the radial adjustment 7 of the carrier shaft 5 at the housing 3 axially in the direction of the touch probe lever takes place after the supporting contact 9 of the carrier shaft 5 on the housing 3 (cf first support/guide or mating surface 59 normal to the axis at the stub 23 and second support/guide or mating surface 61 normal to the axis at the connecting flange 29). As illustrated in FIG. 1 and FIG. 2, the plane of the adjustment 91 is thus displaced axially in the direction of the touch probe lever after the support plane 93 (cf FIG. 1/FIG. 2 – scarrier shaft on the housing axially in the direction of the touch probe lever after the supporting contact of the carrier shaft on the housing).

Put in simplified and descriptive terms, the adjustment 9 is shifted towards the housing after the bearing contact, and inside the housing contour, as a result of which the tactile measurement device 1 has a more compact, shorter and more stable structure. The adjustment accuracy, and furthermore also the measurement accuracy, are increased.

Although the invention has been illustrated and described in detail by the preferred exemplary embodiments, the invention is not limited by the disclosed examples and other variants can be derived therefrom without going beyond the protective scope of the invention.

The following is a summary list of reference numerals and the corresponding structure used in the above description of the invention:

1 tactile measurement device, tactile measurement instrument, multi-coordinate tactile measurement instrument

3 housing

5 carrier shaft

7 (radial) adjustment, centering mounting

9 supporting contact

11 main coordinate axis / measurement axis

13 carrier shaft axis

15 touch probe lever

17 centering/adjustment opening

21 universal joint

23 stub

25 opening (at the housing for the bush)

27 play

29 connecting flange

31 annular extension/portion

33 touch probe / measuring arm

35 coupling arm

37 touch probe end with touch probe element, touch probe element, touch probe / measuring tip

39 annular groove

41 set screw / adjustment screw

45 bush

47 (digital) displacement measurement device with digital displacement sensor and display

55 threaded hole (for adjustment screw)

57 bore/opening (in the housing for adjustment screw)

59 first support/guide or mating surface, normal to the axis, at the stub 23

61 second support/guide or mating surface, normal to the axis, at the connecting flange 29

63 pivot point

65 (sleeve-shaped) coupling piece

67 ball joint

69 return spring

71 touch probe reference point

73 guide opening

75 inner control surface

77 outer control surface

79 axial end side (of the stub 23)

81 internal thread (in the bush 45)

83 axial clamping screw

85 axial bore (in the carrier shaft 5 for the axial clamping screw 83)

87 end side (facing the housing) (of the connecting flange 29)

89 groove-side wall (of the stub 23)

91 plane for (radial) adjustment / centring mounting

93 support plane

95 axial dislocation of the radial adjustment of the carrier shaft at the housing axially in the direction of the touch probe lever after the supporting contact of the carrier shaft on the housing

1. A tactile measurement device, comprising:
a housing;
a touch probe lever mounted in said housing; and
a carrier shaft fastened on said housing and radially adjustably supported on said housing, the radial adjustment of said carrier shaft on said housing is made axially in a direction of said touch probe lever after a supporting contact of said carrier shaft on said housing.

2. The tactile measurement device according to claim 1, wherein said carrier shaft has at one end a connecting flange which has an annular extension forming a centring or adjustment opening.

3. The tactile measurement device according to claim 2, wherein said housing has an annular groove formed therein defining a stub.

4. The tactile measurement device according to claim 3, wherein:
said stub is formed as a single piece with said housing; and/or
said housing having other outer surfaces protruding beyond an axial end side of said stub.

5. The tactile measurement device according to claim 3, wherein said annular extension/portion engages in said annular groove with radial play.

6. The tactile measurement device according to claim 2, wherein said annular extension has a plurality of threaded holes formed therein and disposed uniformly distributed over a circumference, for receiving adjustment screws.

7. The tactile measurement device according to claim 3, wherein:
a first support or mating surface, defining part of said supporting contact, at said stub or at an end side of said stub; and
a corresponding second support or mating surface, further defining said supporting contact, is formed at said connecting flange or at an end side of said connecting flange.

8. The tactile measurement device according to claim 7, wherein said corresponding second support or mating surface is formed at said connecting flange radially inside said annular extension of said connecting flange.

9. The tactile measurement device according to claim 3,
further comprising an axial clamping screw; and
wherein said carrier shaft has an axial bore formed therein for receiving said axial clamping screw and by means of said axial clamping screw said carrier shaft is screwed to said housing.

10. The tactile measurement device according to claim 3,
wherein said housing has an opening formed therein; and
further comprising a bush disposed in said opening of said housing, said bush receiving said axial clamping screw.

11. The tactile measurement device according to claim 1, wherein said touch probe lever is pivotable about a pivot point and has at a first end of said pivot point a touch probe, a measuring arm having said touch probe or a measuring tip, and at a second end of said pivot point a coupling arm, wherein said coupling arm has a free end with an outer control surface formed at said free end.

12. The tactile measurement device according to claim 11, further comprising a sleeve-shaped coupling piece being guided displaceable in said housing axially in a direction of a main coordinate axis or measurement axis which forms an inner control surface, bearing against said outer control surface, in a form of a frustoconical surface.

13. The tactile measurement device according to claim 1, wherein the tactile measurement device is a multi-coordinate tactile measurement instrument.

14. The tactile measurement device according to claim 6, wherein said annular extension has at least three said threaded holes formed therein.

15. The tactile measurement device according to claim 10, wherein:
said opening in said housing is formed in said stub of said housing; and
said bush has an internal thread for receiving said axial clamping screw.

16. The tactile measurement device according to claim 11, wherein said outer control surface is a convex or spherical outer control surface.

17. The tactile measurement device according to claim 7, wherein said supporting contact is normal to an axis.

18. The tactile measurement device according to claim 12, wherein said frustoconical surface of said sleeve-shaped coupling piece has a linear generatrix.
